(19) United States
(12) Patent Application Publication
(10) Pub. No.: US 2026/0197076 A1
(43) Pub. Date: Jul. 9, 2026

(54) OPTICAL TRANSCEIVER

(71) Applicant: Mitsubishi Electric Corporation, Tokyo (JP)

(72) Inventors: Junya NISHIOKA, Tokyo (JP); Yuta TAKEMOTO, Tokyo (JP); Keita MOCHIZUKI, Tokyo (JP)

(73) Assignee: Mitsubishi Electric Corporation, Tokyo (JP)

(21) Appl. No.: 19/557,902

(22) Filed: Mar. 5, 2026

Related U.S. Application Data
(63) Continuation of application No. PCT/JP2023/039537, filed on Nov. 2, 2023.

(51) Int. Cl. H04B 10/079; H04B 10/40

(52) U.S. Cl. CPC H04B 10/0795; H04B 10/40

(57) ABSTRACT

An optical transceiver includes: a pseudo-random number code generator to output a signal indicating a pseudo-random number code; a digital optical transmitter to generate and transmit transmission light on the basis of the signal; an analog optical receiver to receive input light as reception light and convert the reception light into a reception signal; a transmission/reception switch to output the transmission light to one end of an optical fiber, and output light from the optical fiber to the analog optical receiver; a correlation processing unit to calculate loss curve data by performing correlation processing between the signal indicating the pseudo-random number code and the reception signal; a differential processing unit to calculate loss curve differential data on the basis of the loss curve data; and a difference calculation unit to calculate a difference between loss differential data obtained before installation of the optical fiber, and the loss curve differential data.

### CROSS REFERENCE TO RELATED APPLICATION

This application is a Continuation of PCT International Application No. PCT/JP2023/039537, filed on Nov. 2, 2023, which is hereby expressly incorporated by reference into the present application.

### TECHNICAL FIELD

The present disclosure relates to an optical transceiver that can measure optical loss.

### BACKGROUND ART

Conventionally, there has been known a device for obtaining radiation dose distribution information (see, for example, Patent Literature 1). The device disclosed in Patent Literature 1 uses an OTDR measurement method based on a single pulse scheme that is driven by a light source whose pulse width is tw and whose pulse period is tp to obtain radiation dose distribution information along an optical fiber for a sensor.

This method estimates a radiation exposure level, also using wavelength dependency (difference) of a deterioration amount due to radial rays, by performing OTDR processing on a plurality of wavelengths of Stokes light, anti-Stokes light, and the like. Furthermore, Patent Literature 1 also describes that an OTDR measurement method based on a pseudo-random pulse scheme that is driven by a pulse train may be used.

### CITATION LIST

### Patent Literature

Patent Literature 1: JP H04-274787

### SUMMARY OF INVENTION

### Technical Problem

However, the conventional method disclosed in Patent Literature 1 has difficulty in measuring a radiation dose distribution with high distance resolution. Furthermore, the conventional method has difficulty not only in measuring a radiation dose distribution, but also in measuring optical loss with high distance resolution.

Furthermore, according to the conventional method, when OTDR transmission light is converted into a narrower pulse for higher resolution, backscattered power decreases. Hence, in this case, a dynamic range of a measurement distance decreases and loss of an optical fiber under radiation environment increases, and therefore it is difficult to maintain a measurement range.

The present disclosure has been made to solve the above problem, and an object of the present disclosure is to provide an optical transceiver that can measure optical loss with high distance resolution compared to the conventional technique.

### Solution to Problem

An optical transceiver according to the present disclosure includes: a pseudo-random number code generator to output a signal indicating a pseudo-random number code; a digital optical transmitter to generate and transmit transmission light on a basis of the signal indicating the pseudo-random number code output by the pseudo-random number code generator, the digital optical transmitter being able to transmit one Gbit or more; an analog optical receiver to receive input light as reception light and convert the reception light into a reception signal; a transmission/reception switch to output the transmission light transmitted by the digital optical transmitter to one end of an optical fiber, and output light from the optical fiber to the analog optical receiver; an analog-to-digital converter to convert the reception signal from an analog signal into a digital signal on a basis of the reception signal obtained by the analog optical receiver; correlation processing circuitry to calculate loss curve data by performing correlation processing between the signal indicating the pseudo-random number code and the reception signal on a basis of the signal indicating the pseudo-random number code output by the pseudo-random number code generator, and the reception signal obtained by the analog-to-digital converter; differential processing circuitry to calculate loss curve differential data by performing differential processing on a basis of the loss curve data calculated by the correlation processing circuitry; and difference calculation circuitry to calculate a difference between loss differential data and the loss curve differential data on a basis of the loss differential data obtained before installation of the optical fiber, and the loss curve differential data calculated by the differential processing circuitry, in which the digital optical transmitter and the analog optical receiver are configured by a digital optical transceiver, and in which a reception side of the digital optical transceiver includes a limiting amplifier, and the transmission/reception switch outputs leaking light to the reception side of the digital optical transceiver, the leaking light being leaking light of the transmission light transmitted by a transmission side of the digital optical transceiver, and being able to fix a gain of the limiting amplifier.

### ADVANTAGEOUS EFFECTS OF INVENTION

The present disclosure employs the above configuration, and consequently can measure optical loss with high distance resolution compared to the conventional technique.

### BRIEF DESCRIPTION OF DRAWINGS

FIG. 1 is a block diagram illustrating a configuration example of an optical transceiver according to Embodiment 1.

FIG. 2 is a flowchart illustrating an operation example of an optical transceiver according to Embodiment 1.

FIG. 3 is a diagram illustrating an example of loss data and loss curve data handled by the optical transceiver according to Embodiment 1.

FIG. 4 is a diagram illustrating an example of loss differential data, loss curve differential data, and an absorption line cumulative amount distribution handled by the optical transceiver according to Embodiment 1.

FIG. 5 is a block diagram illustrating a configuration example of an optical transceiver according to Embodiment 2.

FIG. 6 is a block diagram illustrating a configuration example of a reception side of a digital optical transceiver according to Embodiment 2.

FIG. 7 is a diagram for explaining a gain of an LA in the optical transceiver according to Embodiment 2 (a case where leaking light is used).

FIG. 8 is a diagram for explaining a gain of the LA in the optical transceiver according to Embodiment 2 (a case where leaking light is small or the leaking light is not used).

FIG. 9 is a block diagram illustrating a configuration example of an optical transmission/reception system according to Embodiment 3.

FIG. 10 is a block diagram illustrating another configuration example of the optical transmission/reception system according to Embodiment 3.

FIG. 11 is a block diagram illustrating a configuration example of an optical transmission/reception system according to Embodiment 4.

FIG. 12 is a flowchart illustrating an operation example of the optical transmission/reception system according to Embodiment 4.

FIG. 13 is a diagram illustrating an example of loss data and loss curve data handled by a first optical transceiver and a second optical transceiver according to Embodiment 4.

FIG. 14 is a diagram illustrating an example of loss differential data, loss curve differential data, and an absorption line cumulative amount distribution handled by the first optical transceiver and the second optical transceiver according to Embodiment 4.

FIG. 15 is a diagram illustrating an example of the absorption line cumulative amount distribution integrated by the optical transceiver according to Embodiment 4.

FIGS. 16A and 16B are block diagrams illustrating hardware configuration examples of the optical transceivers according to Embodiments 1 to 4.

### DESCRIPTION OF EMBODIMENTS

Embodiments will be described in detail below with reference to the drawings.

### Embodiment 1

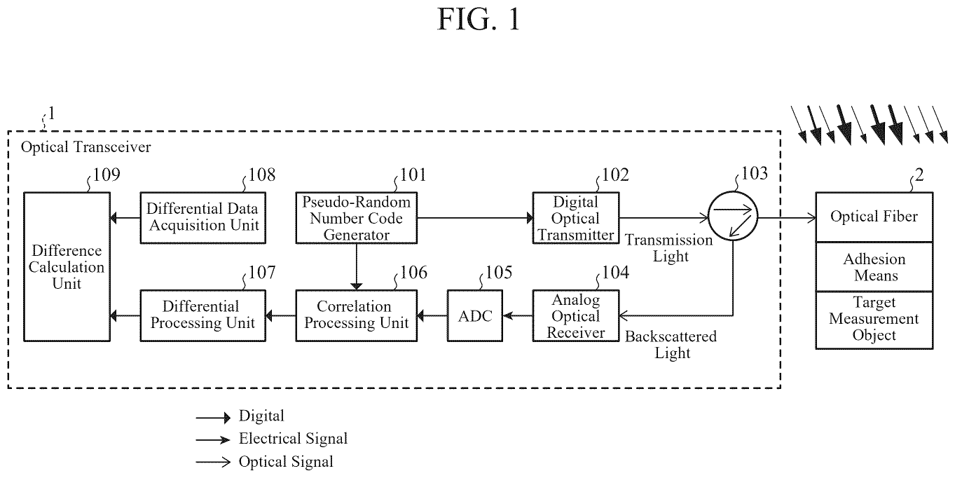

FIG. 1 is a diagram illustrating a configuration example of an optical transceiver 1 according to Embodiment 1. FIG. 1 illustrates an example of a case where the optical transceiver 1 is a fiber-type radiation distribution meter that measures an absorption line cumulative amount distribution (radiation amount distribution). Note that FIG. 1 illustrates the example of the case where an optical fiber 2 is attached to a target measurement object to be irradiated with radial rays with adhesion means interposed therebetween. In FIG. 1, a plurality of arrows illustrated on an upper side of the optical fiber 2 indicate irradiation of radial rays.

Note that this optical transceiver 1 is applicable to, for example, power plants such as satellites and nuclear reactors. Even in a case where, for example, the optical transceiver 1 is applied at a place such as a nuclear reactor in which people cannot enter, the optical transceiver 1 can remotely measure an absorption line cumulative amount distribution.

As illustrated in FIG. 1, this optical transceiver 1 includes a pseudo-random number code generator 101, a digital optical transmitter 102, an optical circulator (transmission/reception switch) 103, an analog optical receiver 104, an Analog-to-Digital Converter (ADC) 105, a correlation processing unit 106, a differential processing unit 107, a differential data acquisition unit 108, and a difference calculation unit 109. This optical transceiver 1 is provided at one end side of the optical fiber 2.

The pseudo-random number code generator 101 generates a pseudo-random number code. That is, the pseudo-random number code generator 101 generates a code in which “0” or “1”s are arranged at random.

A signal indicating the pseudo-random number code generated by this pseudo-random number code generator 101 is output to the digital optical transmitter 102 and the correlation processing unit 106.

The digital optical transmitter 102 generates transmission light on the basis of the signal indicating the pseudo-random number code output by the pseudo-random number code generator 101, and transmits the transmission light to the optical circulator 103. The transmission light generated by this digital optical transmitter 102 is continuous light.

This digital optical transmitter 102 is a digital optical transmitter that can transmit one Gbit or more.

As this digital optical transmitter 102, for example, Small Form-factor Pluggable (SFP) can be used. Furthermore, the digital optical transmitter 102 is not limited to the SFP, and may use high-speed SFP such as SFP+, QSFP, and SFP28, and only has to be a digital optical transmitter that performs On-Off-Keying (OOK) digital modulation.

The optical circulator 103 outputs the transmission light transmitted by the digital optical transmitter 102 to one end of the optical fiber 2.

Furthermore, the optical circulator 103 outputs to the analog optical receiver 104 light (backscattered light) from the optical fiber 2.

Note that FIG. 1 illustrates the case where the optical circulator 103 is used as the transmission/reception switch. However, the transmission/reception switch is not limited to this, and, for example, an optical coupler may be used as the transmission/reception switch.

The analog optical receiver 104 receives the light from the optical circulator 103 as reception light and converts the reception light into a reception signal. The reception signal obtained by the analog optical receiver 104 is an analog signal. The reception signal obtained by this analog optical receiver 104 is output to the ADC 105.

As this analog optical receiver 104, for example, a Photo-Diode (PD) can be used.

The ADC 105 converts the reception signal from an analog signal into a digital signal on the basis of the reception signal obtained by the analog optical receiver 104. The reception signal that is the digital signal obtained by this ADC 105 is output to the correlation processing unit 106.

Note that the ADC 105 may acquire reception signals a plurality of times to improve SNRs of the reception signals, perform averaging processing on the plurality of reception signals, and thereby obtain a reception signal to output to the correlation processing unit 106.

The correlation processing unit 106 calculates loss curve data by performing correlation processing between the signal indicating the pseudo-random number code and the reception signal, on the basis of the signal indicating the pseudo-random number code output by the pseudo-random number code generator 101, and the reception signal obtained by the ADC 105. This loss curve data is data indicating optical loss in a distance direction along the optical fiber 2. A conventionally known calculation method is applicable to the calculation of the loss curve data by this correlation processing unit 106, and description thereof will be omitted. The loss curve data calculated by this correlation processing unit 106 is output to the differential processing unit 107.

The differential processing unit 107 calculates loss curve differential data by performing differential processing on the basis of the loss curve data calculated by the correlation processing unit 106. This loss curve differential data is data indicating a change rate of the optical loss in the distance direction along the optical fiber 2. The loss curve differential data calculated by this differential processing unit 107 is output to the difference calculation unit 109.

The differential data acquisition unit 108 acquires loss differential data obtained before installation of the optical fiber 2. Note that the loss differential data is data indicating the change rate of the optical loss in the distance direction along the optical fiber 2 in a state before the optical fiber 2 is put under a radiation environment, and is measured in advance. The loss differential data acquired by this differential data acquisition unit 108 is output to the difference calculation unit 109.

The difference calculation unit 109 calculates a difference between the loss differential data and the loss curve differential data on the basis of the loss differential data acquired by the differential data acquisition unit 108 and the loss curve differential data calculated by the differential processing unit 107. This difference indicates optical loss per unit length in the distance direction along the optical fiber 2.

Furthermore, in a case where the optical transceiver 1 functions as the fiber-type radiation distribution meter, the difference calculation unit 109 calculates the absorption line cumulative amount distribution on the basis of the above calculated difference. This absorption line cumulative amount distribution is a distribution indicating a radiation dose in the distance direction along the optical fiber 2.

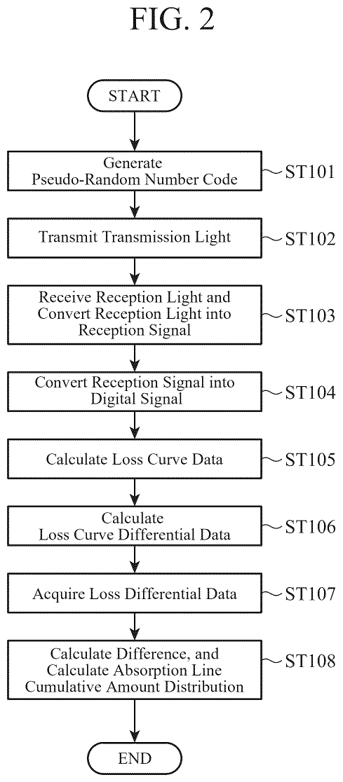

Next, an operation example of the optical transceiver 1 according to Embodiment 1 illustrated in FIG. 1 will be described with reference to FIG. 2. That is, hereinafter, an operation example in a case where the optical transceiver 1 functions as the fiber-type radiation distribution meter will be described.

In the operation example of the optical transceiver 1 according to Embodiment 1 illustrated in FIG. 1, the pseudo-random number code generator 101 first generates a pseudo-random number code as illustrated in, for example, FIG. 2 (step ST101). A signal indicating the pseudo-random number code generated by this pseudo-random number code generator 101 is output to the digital optical transmitter 102 and the correlation processing unit 106.

Next, the digital optical transmitter 102 generates transmission light on the basis of the signal indicating the pseudo-random number code output by the pseudo-random number code generator 101, and transmits the transmission light to the optical circulator 103, and the optical circulator 103 outputs the transmission light to the one end of the optical fiber 2 (step ST102).

Next, the optical circulator 103 outputs to the analog optical receiver 104 light (backscattered light) from the optical fiber 2, and the analog optical receiver 104 receives the light as reception light and converts the reception light into a reception signal (step ST103). The reception signal obtained by this analog optical receiver 104 is output to the ADC 105.

Next, the ADC 105 converts the reception signal obtained by the analog optical receiver 104 from an analog signal into a digital signal (step ST104). The reception signal that is the digital signal obtained by this ADC 105 is output to the correlation processing unit 106.

Next, the correlation processing unit 106 calculates loss curve data by performing correlation processing between the signal indicating the pseudo-random number code and the reception signal, on the basis of the signal indicating the pseudo-random number code output by the pseudo-random number code generator 101, and the reception signal obtained by the ADC 105 (step ST105). The loss curve data calculated by this correlation processing unit 106 is output to the differential processing unit 107.

Next, the differential processing unit 107 calculates loss curve differential data by performing differential processing on the basis of the loss curve data calculated by the correlation processing unit 106 (step ST106). The loss curve differential data calculated by this differential processing unit 107 is output to the difference calculation unit 109.

Furthermore, the differential data acquisition unit 108 acquires loss differential data obtained before installation of the optical fiber 2 (step ST107). The loss differential data acquired by this differential data acquisition unit 108 is output to the difference calculation unit 109.

Next, the difference calculation unit 109 calculates a difference between the loss differential data and the loss curve differential data on the basis of the loss differential data acquired by the differential data acquisition unit 108 and the loss curve differential data calculated by the differential processing unit 107, and calculates an absorption line cumulative amount distribution (step ST108).

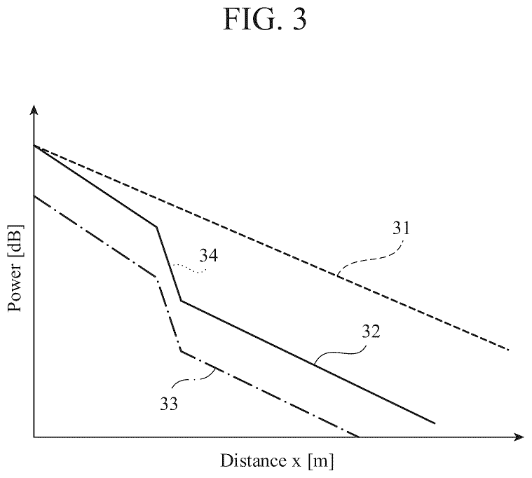

FIG. 3 illustrates an example of loss data and loss curve data handled by the optical transceiver 1 according to Embodiment 1.

In FIG. 3, reference numeral 31 denotes loss data (Lo(x)) obtained before installation of the optical fiber 2, reference numeral 32 denotes loss curve data (L(x)), and reference numeral 33 denotes loss curve data (L(x)) in a case where optical devices (the digital optical transmitter 102 and the analog optical receiver 104) deteriorate. Furthermore, in the example in FIG. 3, a portion denoted by reference numeral 34 is a portion at which optical power remarkably decreases, and is a high radiation exposure portion.

As illustrated in this FIG. 3, optical power entirely decreases as the optical device deteriorates in the loss curve data denoted by reference numeral 33 in the case where the optical device deteriorates compared to the loss curve data denoted by reference numeral 32 in the case where the optical device does not deteriorate.

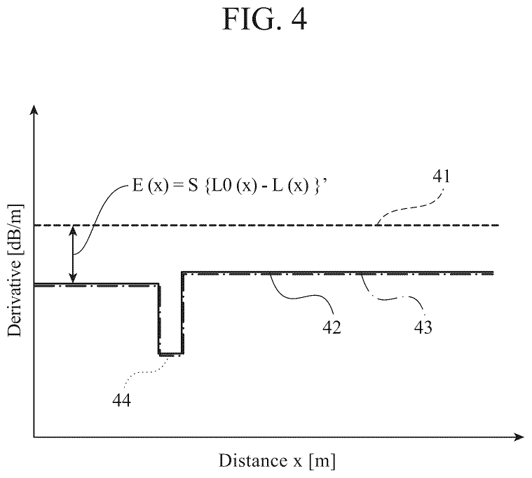

FIG. 4 is a diagram illustrating an example of loss differential data, loss curve differential data, and an absorption line cumulative amount distribution handled by the optical transceiver 1 according to Embodiment 1.

In FIG. 4, reference numeral 41 denotes loss differential data ({Lo(x)}′) obtained before installation of the optical fiber 2, reference numeral 42 denotes loss curve differential data ({L(x)}′), and reference numeral 43 denotes loss curve differential data ({L(x)}′) in a case where an optical device deteriorates. Furthermore, in the example in FIG. 4, a portion denoted by reference numeral 44 is a portion at which power remarkably decreases, and is a high radiation exposure portion.

Furthermore, as illustrated in FIG. 4, the absorption line cumulative amount distribution is E(x)=S{Lo(x)−L(x)}′. Note that S represents a coefficient ([Gy/(dB/m)]) indicating a relationship between a deterioration amount of the optical fiber 2 for a sensor and a radiation dose, and is measured in advance.

As illustrated in this FIG. 4, the loss curve differential data denoted by reference numeral 43 in the case where the optical device deteriorates does not change irrespectively of deterioration of the optical device compared to the loss curve differential data denoted by reference numeral 42 in the case where the optical device does not deteriorate.

As described above, the optical transceiver 1 according to Embodiment 1 can measure optical loss and measure a radiation dose distribution without being influenced by deterioration of optical devices due to radial ray irradiation by calculating a difference between the loss differential data obtained before installation of the optical fiber 2 and the loss curve differential data. That is, according to the optical transceiver 1 according to Embodiment 1, a measurement result of the optical loss and a measurement result of the radiation dose do not change depending on whether or not the optical devices deteriorate by calculating a difference between the loss differential data obtained before installation of the optical fiber 2 and the loss curve differential data.

Furthermore, according to the conventional technique, resolution has been restricted depending on the size of the optical fiber 2 and a pulse width of transmission light.

By contrast with this, the optical transceiver 1 according to Embodiment 1 can obtain high resolution data corresponding to a bit rate of the digital optical transmitter 102. Consequently, the optical transceiver 1 according to Embodiment 1 can detect an increase in local radiation exposure amount or the like by differential processing.

As described above, according to this Embodiment 1, the optical transceiver 1 includes: the pseudo-random number code generator 101 that outputs a signal indicating a pseudo-random number code; the digital optical transmitter 102 that generates and transmits transmission light on the basis of the signal indicating the pseudo-random number code output by the pseudo-random number code generator 101, and can transmit one Gbit or more; the analog optical receiver 104 that receives input light as reception light and converts the reception light into a reception signal; the transmission/reception switch that outputs the transmission light transmitted by the digital optical transmitter 102 to the one end of the optical fiber 2, and outputs light from the optical fiber 2 to the analog optical receiver 104; the ADC 105 that converts the reception signal from an analog signal into a digital signal on the basis of the reception signal obtained by the analog optical receiver 104; the correlation processing unit 106 that calculates loss curve data by performing correlation processing between the signal indicating the pseudo-random number code and the reception signal, on the basis of the signal indicating the pseudo-random number code output by the pseudo-random number code generator 101, and the reception signal obtained by the ADC 105; the differential processing unit 107 that calculates loss curve differential data by performing differential processing on the basis of the loss curve data calculated by the correlation processing unit 106; and the difference calculation unit 109 that calculates a difference between loss differential data and the loss curve differential data, on the basis of the loss differential data obtained before installation of the optical fiber 2, and the loss curve differential data calculated by the differential processing unit 107.

Furthermore, according to Embodiment 1, the digital optical transmitter 102 is a digital optical transmitter that performs OOK modulation.

Consequently, the optical transceiver 1 according to Embodiment 1 can measure optical loss with high distance resolution compared to the conventional technique.

Furthermore, according to this Embodiment 1, the difference calculation unit 109 may calculate the absorption line cumulative amount distribution on the basis of the calculated difference. Consequently, the optical transceiver 1 according to Embodiment 1 can measure a radiation dose distribution with high distance resolution compared to the conventional technique.

### Embodiment 2

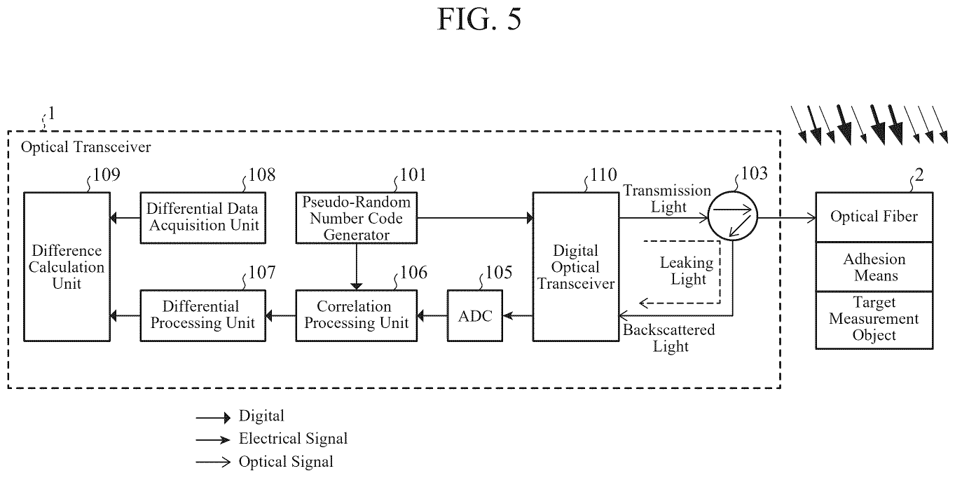

FIG. 5 is a diagram illustrating a configuration example of the optical transceiver 1 according to Embodiment 2. In the optical transceiver 1 according to Embodiment 2 illustrated in this FIG. 5, the digital optical transmitter 102 and the analog optical receiver 104 are configured by a digital optical transceiver 110 compared to the optical transceiver 1 according to Embodiment 1 illustrated in FIG. 1. The other components in the configuration example of the optical transceiver 1 according to Embodiment 2 illustrated in this FIG. 5 are the same as those in the configuration example of the optical transceiver 1 according to Embodiment 1 and will be assigned the same reference numerals, and only different portions will be described.

A transmission side of the digital optical transceiver 110 generates transmission light on the basis of a signal indicating a pseudo-random number code output by the pseudo-random number code generator 101, and outputs the transmission light to the optical circulator 103.

Furthermore, a reception side of the digital optical transceiver 110 receives the light (backscattered light and leaking light) from the optical circulator 103 as reception light and converts the reception light into a reception signal. The reception signal obtained by the reception side of this digital optical transceiver 110 is output to the ADC 105. Furthermore, the reception side of the digital optical transceiver 110 fixes a gain of an LA 1043 to be described later using the leaking light from the optical circulator 103.

This digital optical transceiver 110 is a digital optical transceiver that can transmit one Gbit or more.

As this digital optical transceiver 110, for example, a transmission port and a reception port of SFP can be used. Furthermore, the digital optical transceiver 110 is not limited to the SFP, and may use high-speed SFP such as SFP+, QSFP, and SFP28 and only has to be a digital optical transceiver that performs OOK digital modulation. As this digital optical transceiver 110, for example, a digital optical transceiver for 4 Pulse Amplitude Modulation (PAM4) can be used.

Note that the optical circulator 103 outputs, to the reception side of the digital optical transceiver 110, the leaking light that is leaking light of the transmission light transmitted by the transmission side of the digital optical transceiver 110, and that can fix the gain of the LA 1043. Note that the above leaking light is, for example, −20 dB or more.

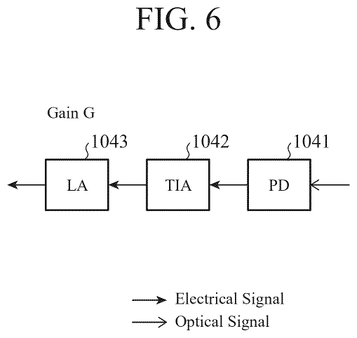

Furthermore, as illustrated in, for example, FIG. 6, the reception side of the digital optical transceiver 110 generally includes a PD 1041, a TransImpedance Amplifier (TIA) 1042, and the Limiting Amplifier (LA) 1043.

The PD 1041 receives the light from the optical circulator 103 as reception light and converts the reception light into an electrical signal. The electrical signal obtained by this PD 1041 is output to the TIA 1042.

The TIA 1042 converts a current of the electrical signal into a voltage on the basis of the electrical signal converted by the PD 1041. The electrical signal converted by this TIA 1042 is output to the LA 1043.

The LA 1043 limits the electrical signal on the basis of the electrical signal converted by the TIA 1042. The electrical signal processed by this LA 1043 is output as the reception signal to the ADC 105.

Here, the LA 1043 operates in such a way as to increase or decrease the gain depending on average optical power, and saturate a voltage amplitude of the input electrical signal with this gain.

By contrast with this, the leaking light is transmission light that has been modulated with the pseudo-random number code and has undergone certain loss, and has no temporal fluctuation of the average power.

Accordingly, by inputting this leaking light to the LA 1043, the gain of the LA 1043 is determined depending on the average power of the leaking light. As a result, a Rayleigh scattering component that is equal to or less than the leaking light and that does not greatly contribute to the average power is output with a substantially certain gain irrespectively of a detection time. Note that the detection time is proportional to a distance.

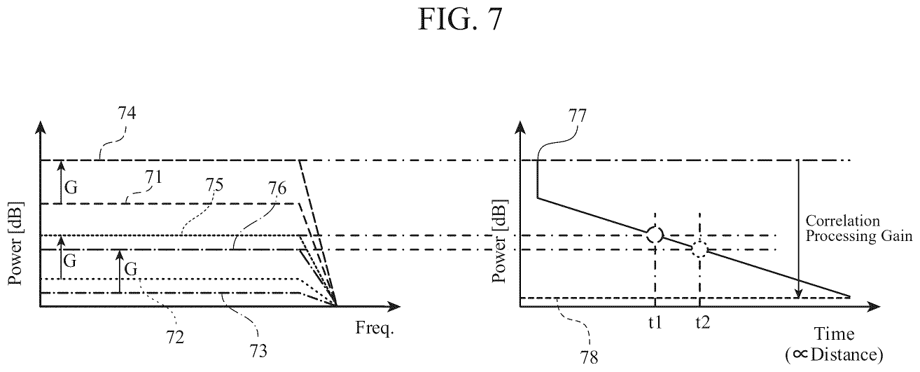

On, for example, a left side in FIG. 7, reference numeral 71 denotes output power of the leaking light component from the TIA 1042, reference numeral 72 denotes output power of the Rayleigh scattering component from the TIA 1042 in a case where a detection time is t1, and reference numeral 73 denotes output power of the Rayleigh scattering component from the TIA 1042 in a case where a detection time is t2 (≠t1). Furthermore, reference numeral 74 denotes output power of the leaking light component from the LA 1043, and the LA 1043 outputs the leaking light of certain power. Furthermore, reference numeral 75 denotes output power of the Rayleigh scattering component from the LA 1043 in a case where the detection time is t1, and reference numeral 76 denotes output power of the Rayleigh scattering component from the LA 1043 in a case where the detection time is t2.

As illustrated on the left side in this FIG. 7, the leaking light input at all times to the reception side of the digital optical transceiver 110 has greater input power than that of the Rayleigh scattering component. Hence, in the LA 1043, a gain (G) is fixed to a gain that saturates this leaking light. As a result, the Rayleigh scattering component in a case where the detection time is t1 and the Rayleigh scattering component in a case where the detection time is t2 are output with the common gain (G) irrespectively of a difference between the detection times, and take analog values.

On the other hand, as illustrated on the right side in FIG. 7, according to the correlation processing, the leaking light component has a high correlation gain only at a point corresponding to an immediate time (near t=0 denoted by reference numeral 77). Consequently, it is possible to detect the Rayleigh scattering component for a period during which a correlation value between the leaking light component and the pseudo-random number code is low, and obtain correct loss curve data.

Note that reference numeral 78 denotes a noise level of the leaking light on the right side in FIG. 7.

As described above, by fixing the gain of the LA 1043 using the leaking light component, it is possible to more correctly obtain the loss curve data.

By contrast with this, the optical transceiver 1 according to Embodiment 2 cannot perform an assumed operation in a case where the leaking light component is small or in a case where there is no leaking light component.

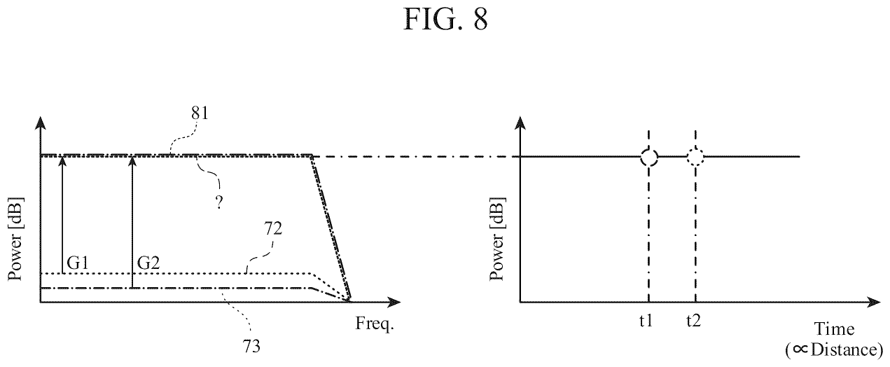

That is, as illustrated on the left side in FIG. 8, in the case where the leaking light component is small or in the case where there is no leaking light component, if the detection time is t1, in the LA 1043, a gain (G1) is fixed to a gain that saturates the Rayleigh scattering component in a case where the detection time is t1, and, if the detection time is t2, in the LA 1043, a gain (G2) is fixed to a gain that saturates the Rayleigh scattering component in a case where the detection time is t2. In this case, as illustrated on the right side in FIG. 8, the Rayleigh scattering component in the case where the detection time is t1 and the Rayleigh scattering component in the case where the detection time is t2 have the substantially same output power, there is no loss change, and a loss curve cannot be correctly obtained.

In FIG. 8, reference numeral 81 denotes output power of the Rayleigh scattering component from the LA 1043 in the case where the detection time is t1 or t2.

Operation examples other than the above operations of the optical transceiver 1 according to Embodiment 2 are the same as the operation examples of the optical transceiver 1 according to Embodiment 1.

As described above, according to this Embodiment 2, the digital optical transmitter 102 and the analog optical receiver 104 are configured by the digital optical transceiver 110, the reception side of the digital optical transceiver 110 includes the LA 1043, and the transmission/reception switch outputs, to the reception side of the digital optical transceiver 110, the leaking light that is leaking light of the transmission light transmitted from the transmission side of the digital optical transceiver 110, and that can fix the gain of the LA 1043.

Furthermore, according to Embodiment 2, the leaking light is −20 dB or more.

Consequently, in addition to the effect of the optical transceiver 1 according to Embodiment 1, the optical transceiver 1 according to Embodiment 2 can use the low-cost digital optical transceiver 110 as the digital optical transmitter 102 and the analog optical receiver 104, and the optical transceiver 1 can be configured at low cost.

### Embodiment 3

Embodiment 2 has described the case where the gain of the LA 1043 is fixed using the leaking light. By contrast with this, Embodiment 3 will describe a case where the gain of the LA 1043 is fixed using transmission light (dummy light) transmitted from a counterpart optical transceiver 1.

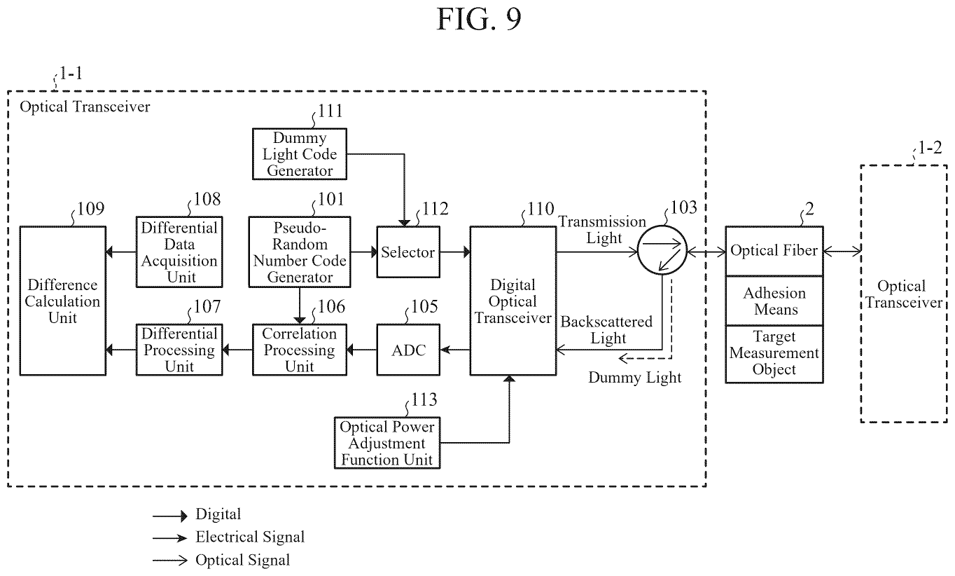

FIG. 9 is a diagram illustrating a configuration example of an optical transmission/reception system according to Embodiment 3.

The optical transmission/reception system includes a pair of the optical transceivers 1 (a first optical transceiver 1-1 and a second optical transceiver 1-2).

The first optical transceiver 1-1 and the second optical transceiver 1-2 are the optical transceivers 1 having the same configuration. These first optical transceiver 1-1 and second optical transceiver 1-2 are disposed facing each other with the optical fiber 2 interposed therebetween. That is, the first optical transceiver 1-1 is provided at the one end side of the optical fiber 2, and the second optical transceiver 1-2 is provided at the other end side of the optical fiber 2. Note that illustration of a detailed configuration of the second optical transceiver 1-2 is omitted in FIG. 9.

In the optical transceiver 1 included in the optical transmission/reception system according to Embodiment 3 illustrated in this FIG. 9, the digital optical transmitter 102 and the analog optical receiver 104 are configured by the digital optical transceiver 110, and a dummy code generator 111, a selector 112, and an optical power adjustment unit 113 are added, with respect to the optical transceiver 1 according to Embodiment 1 illustrated in FIG. 1. The other components in the configuration example of the optical transceiver 1 included in the optical transmission/reception system according to Embodiment 3 illustrated in this FIG. 9 is the same as the components in the configuration example of the optical transceiver 1 according to Embodiment 1 illustrated in FIG. 1 and will be assigned the same reference numerals, and only different portions will be described.

The dummy code generator 111 generates a dummy code. The dummy code is a code that is not correlated with a pseudo-random number code used by the counterpart optical transceiver 1. A signal indicating the dummy code generated by this dummy code generator 111 is output to the selector 112.

The selector 112 outputs, to the transmission side of the digital optical transceiver 110, the signal indicating the pseudo-random number code output by the pseudo-random number code generator 101 or the signal indicating the dummy code output by the dummy code generator 111.

Here, the selector 112 outputs, to the transmission side of the digital optical transceiver 110, the signal indicating the pseudo-random number code output by the pseudo-random number code generator 101 when the own optical transceiver performs measurement. That is, in this case, the selector 112 does not output, to the transmission side of the digital optical transceiver 110, the signal indicating the dummy code output by the dummy code generator 111.

On the other hand, the selector 112 outputs, to the transmission side of the digital optical transceiver 110, the signal indicating the dummy code output by the dummy code generator 111 when the counterpart optical transceiver 1 performs measurement. That is, in this case, the selector 112 does not output, to the transmission side of the digital optical transceiver 110, the signal indicating the pseudo-random number code output by the pseudo-random number code generator 101.

The transmission side of the digital optical transceiver 110 generates transmission light on the basis of a signal output by the selector 112, and outputs the transmission light to the optical circulator 103. Note that, in a case where the digital optical transceiver 110 generates transmission light modulated using the dummy code output by the dummy code generator 111, this transmission light will be also referred to as dummy light. Furthermore, in a case where the dummy code is a code entirely composed of “1”, the dummy light is CW light.

Furthermore, the reception side of the digital optical transceiver 110 receives light (backscattered light and dummy light) from the optical circulator 103 as reception light and converts the reception light into a reception signal. The reception signal obtained by the reception side of this digital optical transceiver 110 is output to the ADC 105. Furthermore, the reception side of the digital optical transceiver 110 fixes the gain of the LA 1043 using the dummy light from the optical circulator 103.

This digital optical transceiver 110 is the digital optical transceiver that can transmit one Gbit or more.

As this digital optical transceiver 110, for example, the transmission port and the reception port of SFP can be used. Furthermore, the digital optical transceiver 110 is not limited to the SFP, and may use high-speed SFP such as SFP+, QSFP, and SFP28 and only has to be a digital optical transceiver that performs OOK digital modulation. As this digital optical transceiver 110, for example, the digital optical transceiver for PAM4 can be used.

The configuration of this digital optical transceiver 110 itself is the same configuration as the configuration of the digital optical transceiver 110 described in Embodiment 2.

The optical power adjustment unit 113 adjusts optical power of the transmission light on the transmission side of the digital optical transceiver 110.

Note that the optical power adjustment unit 113 is not an indispensable component for the optical transceiver 1, and may not be provided to the optical transceiver 1.

Note that FIG. 9 illustrates the case where, in addition to the pseudo-random number code generator 101, the dummy code generator 111 that generates the dummy code is provided to the optical transceiver 1.

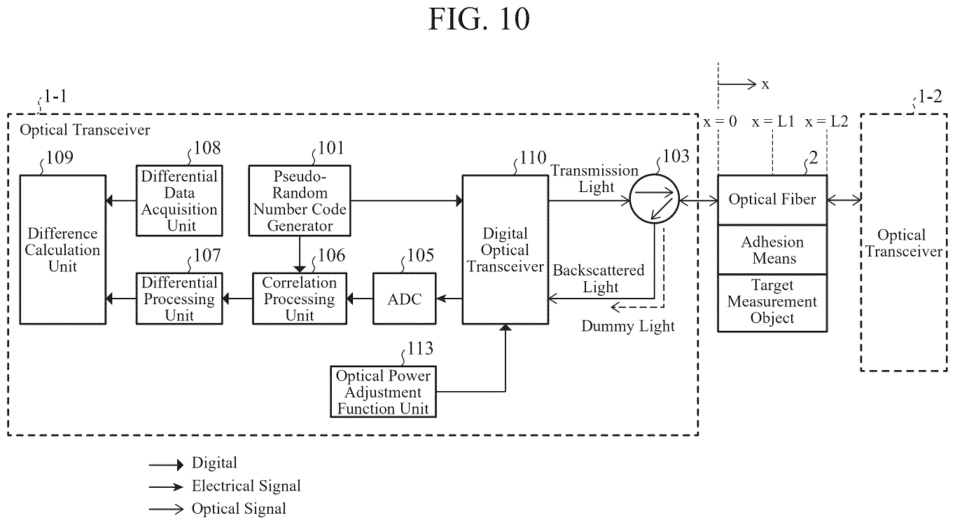

However, the present disclosure is not limited to this, and, as illustrated in, for example, FIG. 10, the dummy code generator 111 may not be provided to the optical transceiver 1, and the pseudo-random number code generator 101 may generate a dummy code that is not correlated with a pseudo-random number code in the counterpart optical transceiver 1 in addition to the pseudo-random number code. In this case, as illustrated in FIG. 10, the selector 112 is unnecessary for the optical transceiver 1.

In a case of a configuration illustrated in FIG. 10, the pseudo-random number code generator 101 generates a pseudo-random number code, and outputs a signal indicating the pseudo-random number code to the transmission side of the digital optical transceiver 110 when the own optical transceiver performs measurement. That is, in this case, the pseudo-random number code generator 101 does not generate the dummy code.

On the other hand, the pseudo-random number code generator 101 generates a dummy code, and outputs a signal indicating the dummy code to the transmission side of the digital optical transceiver 110 when the counterpart optical transceiver 1 performs measurement. That is, in this case, the pseudo-random number code generator 101 does not generate a pseudo-random number code.

Next, an operation example of the optical transmission/reception system according to Embodiment 3 will be described. Here, a case where the first optical transceiver 1-1 performs measurement will be described.

In a case where the first optical transceiver 1-1 performs measurement, the second optical transceiver 1-2 transmits dummy light to the first optical transceiver 1-1 via the optical fiber 2. The dummy code that is a base of this dummy light is a dummy code that is not correlated with a pseudo-random number code used by the first optical transceiver 1-1.

Then, the first optical transceiver 1-1 fixes the gain of the LA 1043 included on the reception side of the digital optical transceiver 110 of the own optical transceiver using the dummy light from this second optical transceiver 1-2. That is, the optical transmission/reception system according to Embodiment 3 fixes the gain of the LA 1043 using the dummy light without using the leaking light described in Embodiment 2.

Note that, when a level of the dummy light is too high, a noise floor becomes high after correlation processing, and cannot be measured. Hence, in such a case, the optical power adjustment unit 113 performs adjustment to lower the optical power of the digital optical transceiver 110, and adjusts the optical power to a measurable level.

Operation examples other than the above operations of the optical transceiver 1 according to Embodiment 3 are the same as the operation examples of the optical transceiver 1 according to Embodiment 1.

As described above, according to this Embodiment 3, the digital optical transmitter 102 and the analog optical receiver 104 are configured by the digital optical transceiver 110, the reception side of the digital optical transceiver 110 includes the LA 1043, and the transmission/reception switch outputs, to the reception side of the digital optical transceiver 110, the transmission light that is transmission light input via the optical fiber 2 and sent from the optical transceiver 1 provided at the other end side of the optical fiber 2, and that is based on the dummy code that is not correlated with the pseudo-random number code used by the own optical transceiver.

Furthermore, according to this Embodiment 3, there are provided the dummy code generator 111 that outputs the signal indicating the dummy code that is not correlated with the pseudo-random number code used by the optical transceiver 1 provided at the other end side of the optical fiber 2, and the selector 112 that outputs the signal indicating the pseudo-random number code output by the pseudo-random number code generator 101 or the signal indicating the dummy code output by the dummy code generator 111, the transmission side of the digital optical transceiver 110 generates and outputs transmission light on the basis of the signal output by the selector 112.

Alternatively, according to this Embodiment 3, the pseudo-random number code generator 101 outputs the signal indicating the pseudo-random number code or the signal indicating the dummy code that is not correlated with the pseudo-random number code used by the optical transceiver 1 provided at the other end side of the optical fiber 2, and a transmission side of the digital optical transceiver 110 generates and outputs transmission light on the basis of a signal output by the pseudo-random number code generator 101.

Consequently, in addition to an effect of the optical transceiver 1 according to Embodiment 1, the optical transceiver 1 according to Embodiment 3 can use the low-cost digital optical transceiver 110 as the digital optical transmitter 102 and the analog optical receiver 104, and thus the optical transceiver 1 can be configured at low cost. Furthermore, the optical transmission/reception system according to Embodiment 3 can relax specification requirement such as the leaking light level of the transmission/reception switch compared to the optical transceiver 1 according to Embodiment 2, and improve level adjustment capability of the optical transceiver 1.

### Embodiment 4

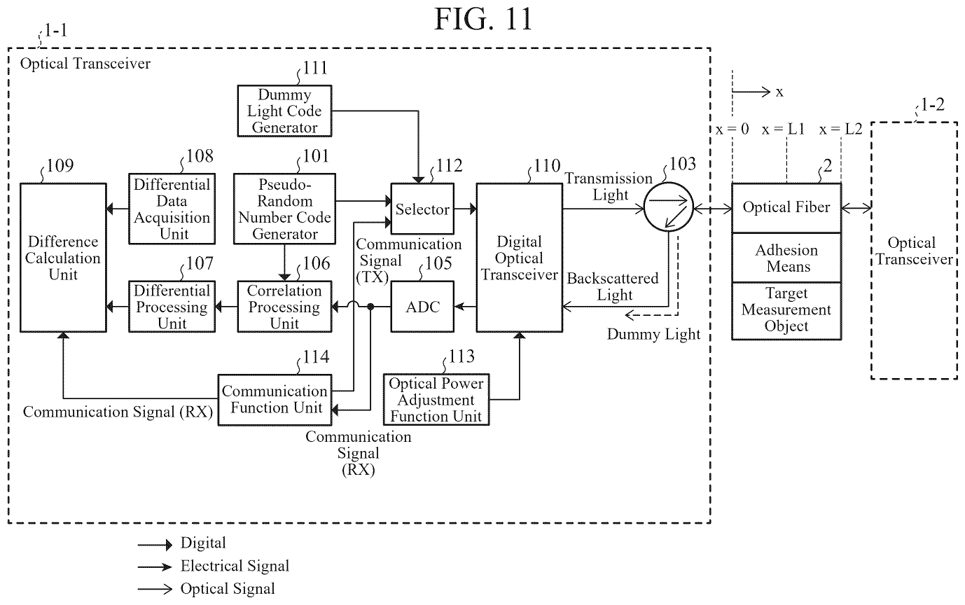

FIG. 11 is a diagram illustrating a configuration example of an optical transmission/reception system according to Embodiment 4.

In an optical transceiver 1 included in the optical transmission/reception system according to Embodiment 4 illustrated in FIG. 11, a communication function unit 114 is added compared to the optical transceiver 1 included in the optical transmission/reception system according to Embodiment 3 illustrated in FIG. 9. The other components in the configuration example of the optical transceiver 1 included in the optical transmission/reception system according to Embodiment 4 illustrated in this FIG. 11 is the same as those in the configuration example of the optical transceiver 1 included in the optical transmission/reception system according to Embodiment 3 illustrated in FIG. 9 and will be assigned the same reference numerals, and only different portions will be described.

Note that the reception signal obtained by the ADC 105 is output to the correlation processing unit 106 and the communication function unit 114.

The communication function unit 114 outputs a calculation result of the difference calculation unit 109 as a communication signal (TX) to the selector 112.

Furthermore, the communication function unit 114 acquires a communication signal (RX) from the counterpart optical transceiver 1 from the reception signal obtained by the ADC 105. Then, the communication function unit 114 outputs the above acquired communication signal to the difference calculation unit 109.

Note that the selector 112 outputs to the transmission side of the digital optical transceiver 110 the signal indicating the pseudo-random number code output by the pseudo-random number code generator 101, the signal indicating the dummy code output by the dummy code generator 111, or the communication signal (TX) output by the communication function unit 114.

Here, the selector 112 outputs, to the transmission side of the digital optical transceiver 110, the signal indicating the pseudo-random number code output by the pseudo-random number code generator 101 when the own optical transceiver performs measurement. That is, in this case, the selector 112 does not output, to the transmission side of the digital optical transceiver 110, the signal indicating the dummy code output by the dummy code generator 111 and the communication signal (TX) output by the communication function unit 114.

Furthermore, the selector 112 outputs, to the transmission side of the digital optical transceiver 110, the signal indicating the dummy code output by the dummy code generator 111 when the counterpart optical transceiver 1 performs measurement. That is, in this case, the selector 112 does not output to the transmission side of the digital optical transceiver 110, the signal indicating the pseudo-random number code output by the pseudo-random number code generator 101 and the communication signal (TX) output by the communication function unit 114.

On the other hand, the selector 112 outputs, to the transmission side of the digital optical transceiver 110, the communication signal (TX) output by the communication function unit 114 when communication is performed with the counterpart optical transceiver 1. That is, in this case, the selector 112 does not output, to the transmission side of the digital optical transceiver 110, the signal indicating the pseudo-random number code output by the pseudo-random number code generator 101 and the signal indicating the dummy code output by the dummy code generator 111.

Furthermore, the transmission side of the digital optical transceiver 110 generates transmission light on the basis of a signal output by the selector 112, and outputs the transmission light to the optical circulator 103.

Furthermore, the difference calculation unit 109 integrates calculation results on the basis of a calculation result of the difference calculation unit 109 and a calculation result that is the communication signal (RX) acquired by the communication function unit 114 and that is obtained by the difference calculation unit 109 of the counterpart optical transceiver 1.

Note that the ADC 105 may output the reception signal to the correlation processing unit 106 and the communication function unit 114 at all times, or may output the reception signal to the correlation processing unit 106 or the communication function unit 114 by switching between the correlation processing unit 106 and the communication function unit 114 as an output destination depending on switching of the selector 112.

When the ADC 105 switches the output destination, the ADC 105 may output the reception signal to the correlation processing unit 106 if the own optical transceiver performs measurement, and outputs the reception signal to the communication function unit 114 if communication is performed with the counterpart optical transceiver 1.

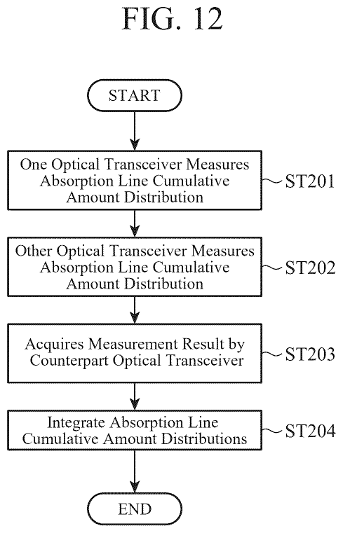

Next, an operation example of the optical transmission/reception system according to Embodiment 4 illustrated in FIG. 11 will be described with reference to FIG. 12. Hereinafter, an operation example in a case where the first optical transceiver 1-1 and the second optical transceiver 1-2 function as the fiber-type radiation distribution meters will be described.

First, the one optical transceiver 1 measures an absorption line cumulative amount distribution (step ST201). For example, the first optical transceiver 1-1 measures the absorption line cumulative amount distribution. A measurement operation at this time is the same as the operation described in Embodiment 3.

Thereafter, the other optical transceiver 1 measures an absorption line cumulative amount distribution (step ST202). For example, the second optical transceiver 1-2 measures the absorption line cumulative amount distribution. A measurement operation at this time is the same as the operation described in Embodiment 3.

Then, after the first optical transceiver 1-1 and the second optical transceiver 1-2 complete measurement of the absorption line cumulative amount distributions, the one optical transceiver 1 acquires a measurement result of the other optical transceiver 1 (step ST203). For example, the first optical transceiver 1-1 acquires a measurement result of the second optical transceiver 1-2. At this time, the first optical transceiver 1-1 and the second optical transceiver 1-2 operate in a communication mode, the second optical transceiver 1-2 transmits, as the communication signal (TX), data indicating the absorption line cumulative amount distribution calculated by the second optical transceiver 1-2, and the first optical transceiver 1-1 acquires the communication signal (TX) as the communication signal (RX). Consequently, the first optical transceiver 1-1 can acquire data indicating the absorption line cumulative amount distribution from the second optical transceiver 1-2.

Thereafter, the one optical transceiver 1 integrates the absorption line cumulative amount distributions (step ST204). For example, the first optical transceiver 1-1 integrates the absorption line cumulative amount distributions. At this time, the first optical transceiver 1-1 integrates the absorption line cumulative amount distribution calculated by the first optical transceiver 1-1 and the absorption line cumulative amount distribution calculated by the second optical transceiver 1-2.

Here, as illustrated in, for example, FIG. 11, a coordinate of one end of the optical fiber 2 that is on the first optical transceiver 1-1 side is x=0, and a coordinate of the other end of the optical fiber 2 that is on the second optical transceiver 1-2 side is x=L2. Furthermore, an intermediate position between these coordinates is x=L1.

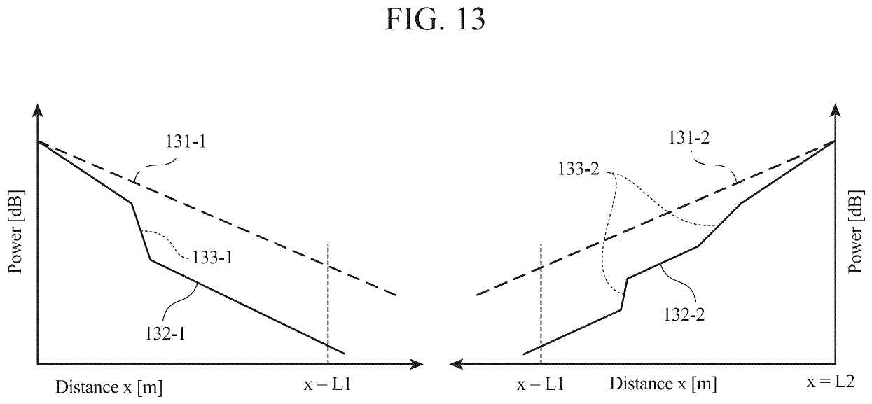

In this case, first, the first optical transceiver 1-1 calculates loss curve data illustrated on the left side in FIG. 13, and the second optical transceiver 1-2 calculates loss curve data illustrated on the right side in FIG. 13.

Note that, in FIG. 13, reference numerals 131-1 and 131-2 denote loss data (Lo(x)) obtained before installation of the optical fiber 2, and reference numerals 132-1 and 132-2 denote loss curve data (L(x)). In the example in this FIG. 13, portions denoted by reference numerals 133-1 and 133-2 are portions at which optical power remarkably decreases, and are high radiation exposure portions.

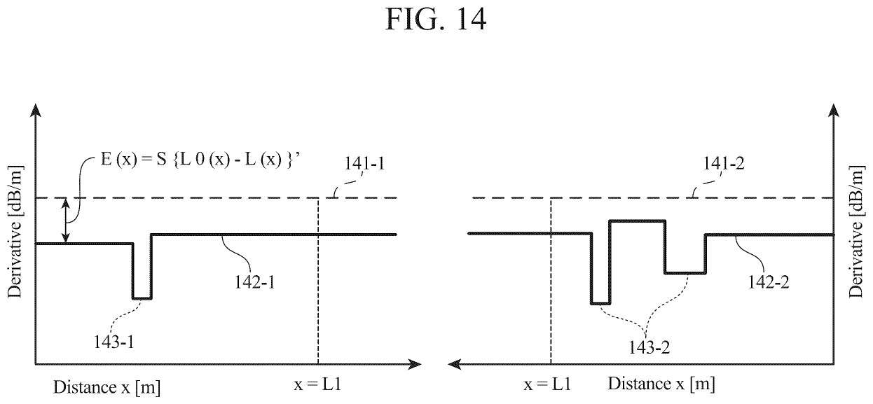

Thereafter, the first optical transceiver 1-1 calculates loss curve differential data and an absorption line cumulative amount distribution illustrated on the left side in FIG. 14, and the second optical transceiver 1-2 calculates loss curve differential data and an absorption line cumulative amount distribution illustrated on the right side in FIG. 14.

Note that, in FIG. 14, reference numerals 141-1 and 141-2 denote loss differential data ({Lo(x)}′) obtained before installation of the optical fiber 2, and reference numerals 142-1 and 142-2 denote loss curve differential data ({L(x)}′). In the example in this FIG. 14, portions denoted by reference numerals 143-1 and 143-2 are portions at which power remarkably decreases, and are high radiation exposure portions.

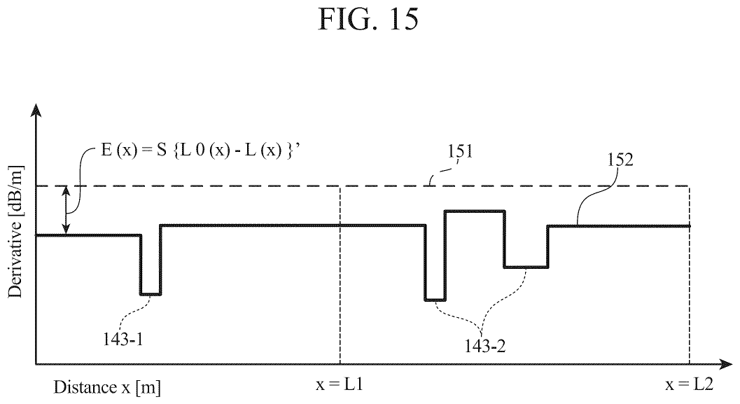

Then, as illustrated in FIG. 15, the first optical transceiver 1-1 integrates data by connecting the absorption line cumulative amount distributions at the coordinates where results have been obtained by both of the optical transceivers 1-1 and 1-2. In the example in FIG. 14, both of the first optical transceiver 1-1 and the second optical transceiver 1-2 measure the absorption line cumulative amount distributions at x=L1. Consequently, in this case, the first optical transceiver 1-1 can integrate the data by connecting the absorption line cumulative amount distributions mutually at this x=L1.

Note that, in FIG. 15, reference numeral 151 denotes loss differential data ({Lo(x)}′) (after integration) obtained before installation of the optical fiber 2, and reference numeral 152 denotes loss curve differential data ({L(x)}′) (after integration).

Note that an operation example in a case where the first optical transceiver 1-1 and the second optical transceiver 1-2 function as the fiber-type radiation distribution meters has been described above. However, the present disclosure is not limited to this, and, in a case where the first optical transceiver 1-1 and the second optical transceiver 1-2 measure optical loss, the optical loss may be integrated.

Note that the case where the communication function unit 114 has been added to the optical transceiver 1 according to Embodiment 3 illustrated in FIG. 9 has been described above. However, the present disclosure is not limited to this, and the communication function unit 114 and the selector 112 may be added to the optical transceiver 1 according to Embodiment 2 or the optical transceiver 1 according to Embodiment 3 illustrated in FIG. 10, and the same effect as the above effect can be obtained.

Note that, in the case where the communication function unit 114 and the selector 112 are added to the optical transceiver 1 according to Embodiment 2, that is, in a case where the communication function unit 114 and the selector 112 are added to the configuration that fixes the gain of the LA 1043 using leaking light, when the one optical transceiver 1 performs measurement, the other optical transceiver 1 sets an output of transmission light to 0 or turns off the transmission side of the digital optical transceiver 110.

As described above, according to this Embodiment 4, there are provided the communication function unit 114 that outputs data indicating the calculation result of the difference calculation unit 109 as a communication signal, and acquires from the reception signal obtained by the analog-to-digital converter 105 the communication signal from the optical transceiver 1 provided at the other end side of the optical fiber 2, and the selector 112 that outputs the signal indicating the pseudo-random number code generated by the pseudo-random number code generator 101 or the communication signal output by the communication function unit 114, the transmission side of the digital optical transceiver 110 generates and outputs transmission light on the basis of the signal output by the selector 112, and the difference calculation unit 109 integrates calculation results on the basis of the calculation result and the communication signal acquired by the communication function unit 114. Consequently, the optical transmission/reception system according to Embodiment 4 can improve a dynamic range of a measurement distance in addition to the effects of the optical transceivers 1 according to Embodiments 2 and 3.

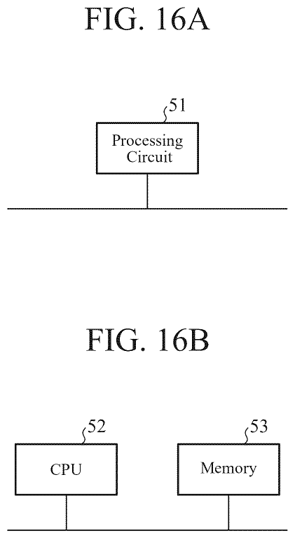

Lastly, hardware configuration examples of the optical transceivers 1 according to Embodiments 1 to 4 will be described with reference to FIG. 16. Although the hardware configuration example of the optical transceiver 1 according to Embodiment 1 will be described below, the same applies to the hardware configuration examples of the optical transceivers 1 according to Embodiments 2 to 4.

The functions of the pseudo-random number code generator 101, the ADC 105, the correlation processing unit 106, the differential processing unit 107, and the difference calculation unit 109 in the optical transceiver 1 are implemented by a processing circuit 51. The processing circuit 51 may be dedicated hardware as illustrated in FIG. 16A, or may be a CPU (that is also referred to as a Central Processing Unit, a central processing device, a processing device, an arithmetic operation device, a microprocessor, a microcomputer, a processor, or a Digital Signal Processor (DSP)) 52 that executes programs stored in a memory 53 as illustrated in FIG. 16B.

In a case where the processing circuit 51 is the dedicated hardware, the processing circuit 51 corresponds to, for example, a single circuit, a composite circuit, a programmed processor, a parallel-programmed processor, an Application Specific Integrated Circuit (ASIC), a Field-Programmable Gate Array (FPGA), or a combination thereof. Each function of each of the pseudo-random number code generator 101, the ADC 105, the correlation processing unit 106, the differential processing unit 107, and the difference calculation unit 109 may be implemented by the processing circuit 51 or the functions of the units may be collectively implemented by the processing circuit 51.

In a case where the processing circuit 51 is the CPU 52, the functions of the pseudo-random number code generator 101, the ADC 105, the correlation processing unit 106, the differential processing unit 107, and the difference calculation unit 109 are implemented by software, firmware, or a combination of software and firmware. The software and the firmware are described as programs, and stored in the memory 53. The processing circuit 51 implements the function of each unit by reading and executing the programs stored in the memory 53. That is, the optical transceiver 1 includes the memory that stores such programs that each step illustrated in, for example, FIG. 2 is eventually executed when executed by the processing circuit 51. Furthermore, these programs cause a computer to execute a procedure and a method of the pseudo-random number code generator 101, the ADC 105, the correlation processing unit 106, the differential processing unit 107, and the difference calculation unit 109. Here, the memory 53 corresponds to, for example, a non-volatile or volatile semiconductor memory such as a Random Access Memory (RAM), a Read Only Memory (ROM), a flash memory, an Erasable Programmable Read Only Memory (EPROM), or an Electrically EPROM (EEPROM), a magnetic disk, a flexible disk, an optical disk, a compact disk, a mini disk, a Digital Versatile Disc (DVD), or the like.

Note that part of the functions of the pseudo-random number code generator 101, the ADC 105, the correlation processing unit 106, the differential processing unit 107, and the difference calculation unit 109 may be implemented as dedicated hardware, and part of the functions may be implemented as software or firmware. For example, the function of the pseudo-random number code generator 101 can be implemented by the processing circuit 51 that is the dedicated hardware, and the functions of the ADC 105, the correlation processing unit 106, the differential processing unit 107, and the difference calculation unit 109 can be implemented by the processing circuit 51 by reading and executing the programs stored in the memory 53.

Thus, the processing circuit 51 can implement each of the above-described functions as hardware, software, firmware, or a combination thereof.

Note that the embodiments can be freely combined, any components in the embodiments can be modified, or any components in the embodiments can be omitted.

### INDUSTRIAL APPLICABILITY

The optical transceiver 1 according to the present disclosure can measure optical loss with high distance resolution compared to the conventional technique, and is suitable for use in the optical transceiver 1 that can measure optical loss, for example.

### REFERENCE SIGNS LIST

1: Optical transceiver, 1-1: First optical transceiver, 1-2: Second optical transceiver, 2: Optical fiber, 51: Processing circuit, 52: CPU, 53: Memory, 101: Pseudo-random number code generator, 102: Digital optical transmitter, 103: Optical circulator (transmission/reception switch), 104: Analog optical receiver, 105: ADC (Analog-to-Digital Converter), 106: Correlation processing unit, 107: Differential processing unit, 108: Differential data acquisition unit, 109: Difference calculation unit, 110: Digital optical transceiver, 111: Dummy code generator, 112: Selector, 113: Optical power adjustment unit, 114: Communication function unit, 1041: PD, 1042: TIA, 1043: LA

1. An optical transceiver comprising:
a pseudo-random number code generator to output a signal indicating a pseudo-random number code;
a digital optical transmitter to generate and transmit transmission light on a basis of the signal indicating the pseudo-random number code output by the pseudo-random number code generator, the digital optical transmitter being able to transmit one Gbit or more;
an analog optical receiver to receive input light as reception light and convert the reception light into a reception signal;
a transmission/reception switch to output the transmission light transmitted by the digital optical transmitter to one end of an optical fiber, and output light from the optical fiber to the analog optical receiver;
an analog-to-digital converter to convert the reception signal from an analog signal into a digital signal on a basis of the reception signal obtained by the analog optical receiver;
correlation processing circuitry to calculate loss curve data by performing correlation processing between the signal indicating the pseudo-random number code and the reception signal on a basis of the signal indicating the pseudo-random number code output by the pseudo-random number code generator, and the reception signal obtained by the analog-to-digital converter;
differential processing circuitry to calculate loss curve differential data by performing differential processing on a basis of the loss curve data calculated by the correlation processing circuitry; and
difference calculation circuitry to calculate a difference between loss differential data and the loss curve differential data on a basis of the loss differential data obtained before installation of the optical fiber, and the loss curve differential data calculated by the differential processing circuitry,
wherein the digital optical transmitter and the analog optical receiver are configured by a digital optical transceiver, and
wherein a reception side of the digital optical transceiver includes a limiting amplifier, and
the transmission/reception switch outputs leaking light to the reception side of the digital optical transceiver, the leaking light being leaking light of the transmission light transmitted by a transmission side of the digital optical transceiver, and being able to fix a gain of the limiting amplifier.

2. An optical transceiver comprising:
a pseudo-random number code generator to output a signal indicating a pseudo-random number code;
a digital optical transmitter to generate and transmit transmission light on a basis of the signal indicating the pseudo-random number code output by the pseudo-random number code generator, the digital optical transmitter being able to transmit one Gbit or more;
an analog optical receiver to receive input light as reception light and convert the reception light into a reception signal;
a transmission/reception switch to output the transmission light transmitted by the digital optical transmitter to one end of an optical fiber, and output light from the optical fiber to the analog optical receiver;
an analog-to-digital converter to convert the reception signal from an analog signal into a digital signal on a basis of the reception signal obtained by the analog optical receiver;
correlation processing circuitry to calculate loss curve data by performing correlation processing between the signal indicating the pseudo-random number code and the reception signal on a basis of the signal indicating the pseudo-random number code output by the pseudo-random number code generator, and the reception signal obtained by the analog-to-digital converter;
differential processing circuitry to calculate loss curve differential data by performing differential processing on a basis of the loss curve data calculated by the correlation processing circuitry; and
difference calculation circuitry to calculate a difference between loss differential data and the loss curve differential data on a basis of the loss differential data obtained before installation of the optical fiber, and the loss curve differential data calculated by the differential processing circuitry,
wherein the digital optical transmitter and the analog optical receiver are configured by a digital optical transceiver, and
wherein a reception side of the digital optical transceiver includes a limiting amplifier, and
the transmission/reception switch outputs the transmission light to a reception side of the digital optical transceiver, the transmission light being the transmission light input via the optical fiber and sent from an optical transceiver provided at another end side of the optical fiber, and being based on a dummy code that is not correlated with the pseudo-random number code used by the own optical transceiver.

3. The optical transceiver according to claim 1, wherein the digital optical transmitter is a digital optical transmitter to perform OOK modulation.

4. The optical transceiver according to claim 2, wherein the digital optical transmitter is a digital optical transmitter to perform OOK modulation.

5. The optical transceiver according to claim 1, wherein the leaking light is-20 dB or more.

6. The optical transceiver according to claim 2, further comprising:
a dummy code generator to output a signal indicating a dummy code that is not correlated with a pseudo-random number code used by the optical transceiver provided at the other end side of the optical fiber; and
a selector to output the signal indicating the pseudo-random number code output by the pseudo-random number code generator or the dummy code output by the dummy code generator,
wherein a transmission side of the digital optical transceiver generates and outputs transmission light on a basis of the signal output by the selector.

7. The optical transceiver according to claim 2, wherein
the pseudo-random number code generator outputs the signal indicating the pseudo-random number code or a signal indicating a dummy code that is not correlated with a pseudo-random number code used by the optical transceiver provided at the other end side of the optical fiber; and
a transmission side of the digital optical transceiver generates and outputs transmission light on a basis of the signal output by the pseudo-random number code generator.

8. The optical transceiver according to claim 1, wherein the difference calculation circuitry calculates an absorption line cumulative amount distribution on a basis of the calculated difference.

9. The optical transceiver according to claim 2, wherein the difference calculation circuitry calculates an absorption line cumulative amount distribution on a basis of the calculated difference.

10. The optical transceiver according to claim 1, further comprising:
communication function circuitry to output data indicating a calculation result of the difference calculation circuitry as a communication signal, and acquire a communication signal sent from an optical transceiver provided at another end side of the optical fiber from the reception signal obtained by the analog-to-digital converter; and
a selector to output the signal indicating the pseudo-random number code generated by the pseudo-random number code generator or a communication signal output by the communication function circuitry, wherein the digital optical transceiver generates and outputs transmission light on a basis of the signal output by the selector, and
the difference calculation circuitry integrates calculation results on a basis of the calculation result and the communication signal acquired by the communication function circuitry.

11. The optical transceiver according to claim 2, further comprising:
communication function circuitry to output data indicating a calculation result of the difference calculation circuitry as a communication signal, and acquire a communication signal sent from the optical transceiver provided at the other end side of the optical fiber from the reception signal obtained by the analog-to-digital converter; and
a selector to output the signal indicating the pseudo-random number code generated by the pseudo-random number code generator or a communication signal output by the communication function circuitry, wherein
the digital optical transceiver generates and outputs transmission light on a basis of the signal output by the selector, and
the difference calculation circuitry integrates calculation results on a basis of the calculation result and the communication signal acquired by the communication function circuitry.
